(19) United States
(12) Patent Application Publication
(10) Pub. No.: US 2011/0203470 A1
(43) Pub. Date: Aug. 25, 2011

(54) IMAGE FORMING APPARATUS AND PROCESSING APPARATUS

(76) Inventors: Hiroshi OYAMA, Tokyo (JP); Kenji Izumiya, Tokyo (JP); Yumiko Higashi, Tokyo (JP); Hidenori Mine, Toyohashi-shi (JP)

(21) Appl. No.: 13/034,452

(22) Filed: Feb. 24, 2011

(30) Foreign Application Priority Data
Feb. 25, 2010 (JP) 2010-039949

(51) Int. Cl. B41L 15/14

(52) U.S. Cl. 101/480

(57) ABSTRACT

Disclosed is an image forming apparatus to form an image on a paper, comprising: a main body section including a housing to house an apparatus to perform processing for the paper, and a control circuit to control the apparatus housed in the housing; and a peripheral apparatus provided separately from the main body section, which includes a hardware module having an electric component, and is connected to the control circuit so that communication therebetween is performed, and which is detachably provided to the housing, wherein a position at which the peripheral apparatus is provided to the housing can be changed, wherein the housing and the peripheral apparatus respectively include a conductive material, and the conductive material of the housing is grounded, and wherein when the peripheral apparatus is provided to the housing, the conductive material of the housing is conductive with the conductive material of the peripheral apparatus.

### CROSS-REFERENCE TO RELATED APPLICATION

The present U.S. patent application claims a priority under the Paris Convention of Japanese patent application No. 2010-039949 filed on Feb. 25, 2010, which shall be a basis of correction of an incorrect translation.

### BACKGROUND OF THE INVENTION

1. Field of the Invention

The present invention relates to an image forming apparatus and a processing apparatus.

2. Description of the Related Art

Among conventional image forming apparatuses for performing image formation based on image data, there has been known an image forming apparatus which includes an image forming section having an image carrier within the image forming apparatus. This image forming apparatus is provided with a peripheral apparatus such as an operation section in an upper portion of the housing of the image forming apparatus. Communication with a control section of the image forming apparatus is performed to provide various operations based on this communication result.

Further, the peripheral apparatus as described above also includes a hardware module such as a control board. This hardware module serves as a source of noise. In order to suppress this noise from reaching outside, various measures have been suggested. For example, an image forming apparatus in which an apparatus body can easily and reliably be subjected to an electric grounding by attaching, to the apparatus body, an operation panel configured by connecting a panel base of the operation panel to an elastic metal member so that the operation panel is conductive with the structure members (see Japanese Patent Application Laid-Open Publication No. 2003-80798) has been proposed. Further, an image forming apparatus structured so that a signal line is separately provided from a conductive member for the grounding of an electric component in an operation panel that is movable by having one pivotally-supported end (see Japanese Patent Application Laid-Open Publication No. 2003-19846) has also been proposed.

By the way, image forming apparatuses in recent years tend to get larger by being additionally connected to an optional apparatus (processing apparatus) such as a paper feeding apparatus or a post-processing apparatus. In such a case, if a peripheral apparatus such as an operation section can be provided at a free position, it is very convenient because the peripheral apparatus can be moved depending on the position at which a user performs operation and this peripheral apparatus can be used in accordance with the operation by the user, for example.

However, in the case of the above image forming apparatus disclosed in Japanese Patent Application Laid-Open Publication No. 2003-80798, a technique is used that provides the conduction between an operation panel fixedly provided to an apparatus body and the apparatus body, which does not take the configuration of freely moving the operation panel into consideration.

Similarly in the case of the image forming apparatus disclosed in Japanese Patent Application Laid-Open Publication No. 2003-19846, a technique is used that provides the conduction between an operation panel movable within a limited range in a body and the body, which does not take the configuration of freely moving the operation panel into consideration, either.

It is an object of the present invention to provide improved user convenience and to provide an effective measure against noise.

### SUMMARY OF THE INVENTION

To achieve at least one of the abovementioned objects, an image forming apparatus, reflecting one aspect of the present invention comprises:

a main body section including a housing to house an apparatus to perform processing for the paper, and a control circuit to control the apparatus housed in the housing; and

a peripheral apparatus which is provided separately from the main body section, which includes a hardware module having an electric component, and is connected to the control circuit so that communication between the peripheral apparatus and the control circuit is performed, and which is detachably provided to the housing, wherein

a position at which the peripheral apparatus is provided to the housing can be changed, wherein

the housing and the peripheral apparatus respectively include a conductive material, and the conductive material of the housing is grounded, and wherein

when the peripheral apparatus is provided to the housing, the conductive material of the housing is conductive with the conductive material of the peripheral apparatus.

To achieve at least one of the abovementioned objects, an image processing apparatus being connected to an image forming apparatus which forms an image on a paper, to perform predetermined processing for the paper subjected to an image formation by the image forming apparatus, reflecting another aspect of the present invention comprises:

a housing to house an apparatus which performs processing for the paper, the housing including a grounded conductive material, wherein

when a peripheral apparatus comprising a conductive material is provided to the housing, the grounded conductive material of the housing is conductive with the conductive material of the peripheral apparatus, the peripheral apparatus further comprising a hardware module including an electric component, and being connected to the image forming apparatus so that communication between the peripheral apparatus and the image forming apparatus is performed, the peripheral apparatus being detachably provided to the housing, and wherein a position at which the peripheral apparatus is provided to the housing can be changed.

### BRIEF DESCRIPTION OF THE DRAWINGS

The present invention will become more fully understood from the detailed description given hereinbelow and the appended drawings, and thus are not intended as a definition of the limits of the present invention, wherein:

FIG. 1 is a schematic view illustrating a cross-sectional configuration of an image forming system;

FIG. 2 is a block diagram illustrating a functional configuration of the image forming system;

FIG. 3 is a block diagram illustrating a functional configuration of an operation unit;

FIG. 4 illustrates how the operation units are attached to the image forming system;

FIG. 5 is a partial cross-sectional view illustrating the operation unit being attached to the image forming apparatus body;

FIG. 6 is a cross-sectional view illustrating a cross section of the operation unit of FIG. 5 taken along the line A-A;

FIG. 7 illustrates another embodiment of a positioning mechanism;

FIG. 8 illustrates another embodiment of the positioning mechanism;

FIG. 9 illustrates another embodiment of a fixing mechanism;

FIG. 10 illustrates another embodiment of the positioning mechanism and the fixing mechanism;

FIG. 11 is a partial cross-sectional view illustrating the cross section taken along the line B-B in FIG. 10;

FIG. 12 illustrates another embodiment of the positioning mechanism and the fixing mechanism;

FIG. 13 illustrates another embodiment of the positioning mechanism and the fixing mechanism;

FIG. 14 illustrates another embodiment of the positioning mechanism and the fixing mechanism;

FIG. 15 is a block diagram illustrating the functional configuration of an optional apparatus according to another embodiment; and

FIG. 16 is a schematic view illustrating the cross-sectional configuration of a conventional image forming system.

### DETAILED DESCRIPTION OF THE PREFERRED EMBODIMENTS

Hereinbelow, description for embodiments of the present invention will be given with reference to the attached drawings, although the scope of the invention is not limited to the shown examples.

In the embodiments of the present invention, the term “image forming system” is used to denote the entire apparatus constituting the invention. Further, the term “image forming apparatus” in the present invention means to include both an image forming apparatus main body and a form including an image forming apparatus main body and other optional apparatuses. In the present invention, the term “processing apparatus” means to include both a form composed of a single optional apparatus and a form including a combination of two or more optional apparatuses.

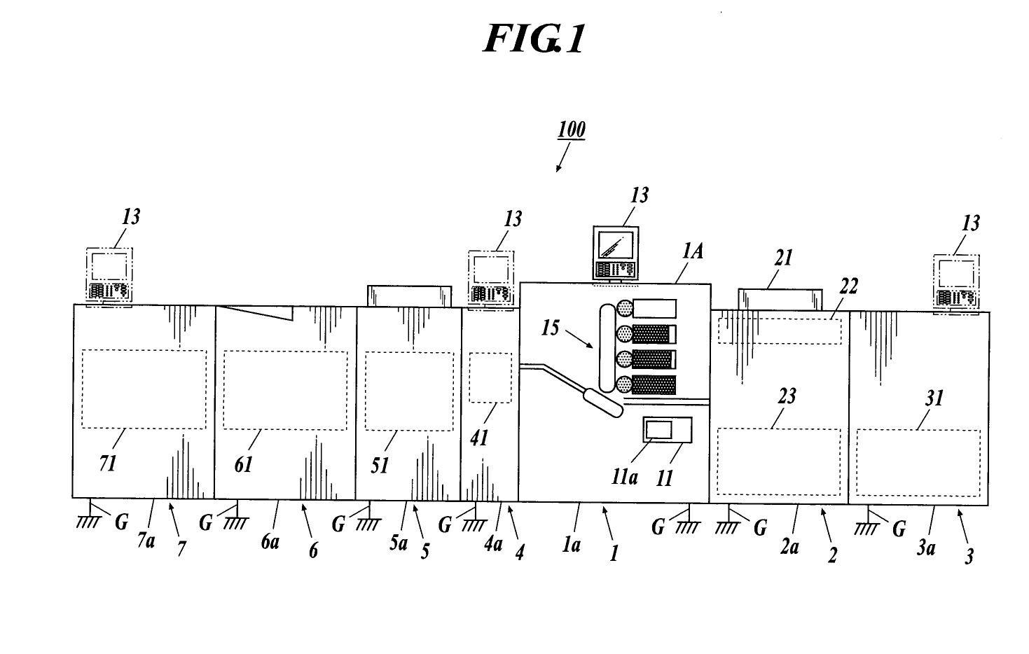

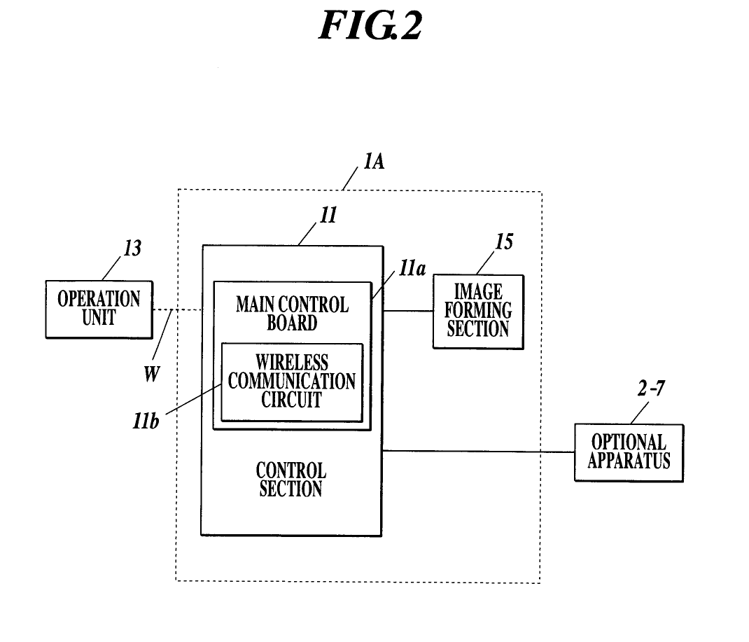

FIG. 1 is a schematic view illustrating the cross-sectional configuration of an image forming system 100 in this embodiment. FIG. 2 illustrates an example of the functional configuration of the image forming system 100 in this embodiment.

As shown in FIG. 1, the image forming system 100 comprises, for example, an image forming apparatus main body 1 and optional apparatuses 2 to 7, which are arranged in a state of being connected to neighboring apparatuses.

The image forming system 100 is configured, as shown in FIG. 2, so that the image forming apparatus main body 1 and the optional apparatuses 2 to 7 are connected so as to transmit and receive data therebetween by serial communication, for example. The image forming apparatus main body 1 is connected to a host computer via a communication network such as a not-shown Local Area Network (LAN) so that data can be transmitted and received therebetween.

As shown in FIGS. 1 and 2, the image forming apparatus main body 1 is configured, for example, to include a main body section 1A, and an operation unit 13 as one embodiment of a peripheral apparatus. The main body section 1A includes a control section 11 and an image forming section 15. The main body section 1A also includes a housing 1a to house the control section 11 and the image forming section 15, and the like, for example.

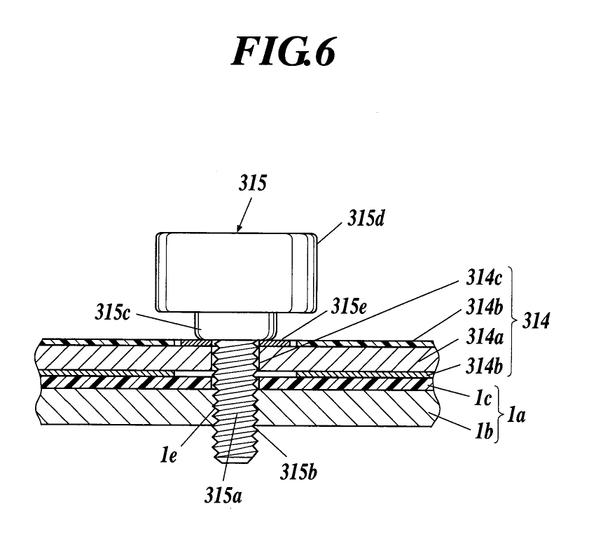

The housing 1a includes a housing main body section 1b and a resin-made housing covering section 1c. The housing main body section 1b is configured as a box of a conductive metal formed by bending the metal to have a square shape. The housing covering section 1c covers the outer surface of the housing main body section 1b (see FIG. 6).

The housing main body section 1b is connected to a ground wire G and is grounded.

Although the housing main body section 1b is composed of a conductive metal, the housing main body section 1b may also be composed of any conductive material including, for example, resin mixed with a conductive material such as silver fibers or carbon. In this case, the housing main body section 1b can also be integrated with the housing covering section 1c. Another configuration may alternatively be one which does not include the housing covering section 1c. Still another configuration may also be one in which a conductive metal is provided only at a part of the housing 1a.

Although the main body section 1A of the image forming apparatus main body 1 of this embodiment is configured to include one housing as described above, the main body section 1A may also be configured to include two or more housings, or may also include apart or the entirety of the housings of other optional apparatuses 2 to 7, which will be described later.

The control section 11 includes a main control board 11a that constitutes a part of a control circuit, and is connected to a detection switch and an actuator (not shown) included in the image forming section 15. The control circuit includes the one composed only of a board such as a main control board 11a, and the one configured not including a board.

The control section 11 performs a control to drive, based on a detection signal from the detection switch of the image forming section 15 or an operation signal from the operation unit 13, the actuator of the image forming section 15 to form an image on a paper. The control section 11 also transmits control instruction data to the optional apparatuses 2 to 7 so as to make the optional apparatuses 2 to 7 perform various operations.

The main control board 11a includes, for example, not-shown electric components such as a Central Processing Unit (CPU) and a memory. The main control board 11a also includes a wireless communication circuit 11b to be connected via wireless W to the operation unit 13 so that communication therebetween can be performed.

The main control board 11a in this embodiment constitutes, together with other apparatuses such as a Hard Disc Drive (HDD) in the control section 11, a circuit for performing the control by the control section 11.

Although not shown, the image forming section 15 is configured, to include a photoreceptor drum, a charging section, Laser Diode (LD), a development section, a transfer section, a cleaning section, a fixing section, a conveying roller, and a conveying belt, for example. The image forming section 15 drives the respective sections according to a control signal from the control section 11, and forms an image on a paper by way of an electrophotographic method. The image forming section 15, as well as the photoreceptor drum, the charging section, the LD, the development section, the transfer section, the cleaning section, the fixing section, the conveying roller, and the conveying belt, for example, that constitute the image forming section 15 are an example of an apparatus for performing a predetermined processing on a paper for image formation.

The operation unit 13 is provided on the upper surface of the housing 1a of the image forming apparatus main body 1. The operation unit 13 is configured, as described later, to be detachably attached to the image forming apparatus main body 1 and the optional apparatuses 2 to 7, and to be able to perform wireless communication with the control section 11 of the image forming apparatus main body 1. Thus, the operation unit 13 can be provided, for example, at any position freely selected by a user, as shown in FIG. 1.

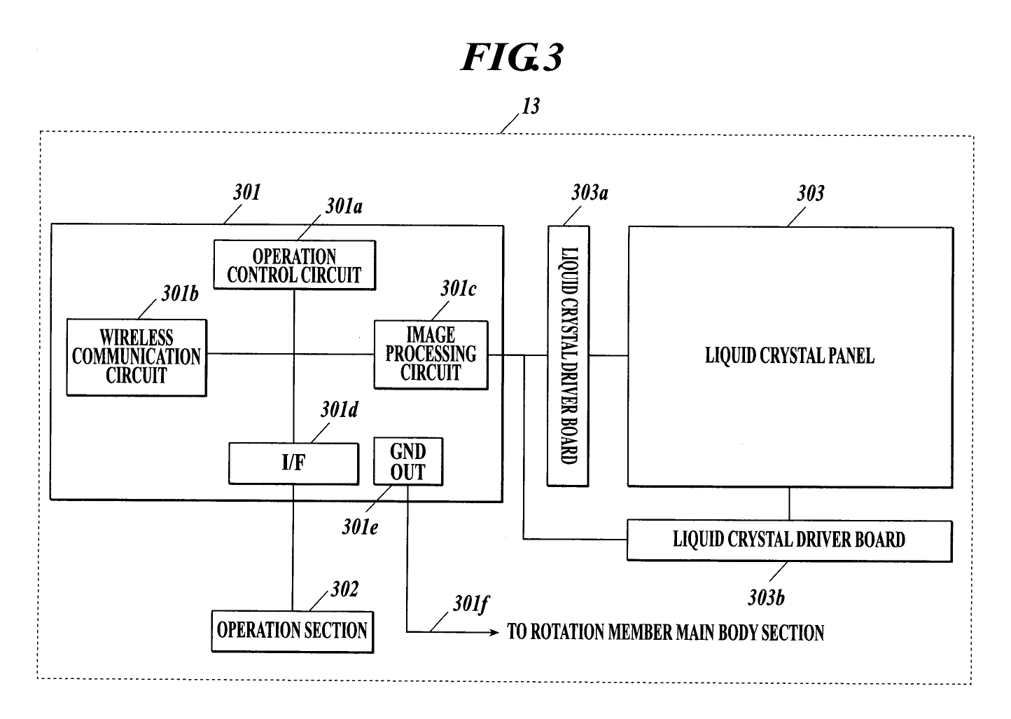

As shown in FIG. 3, the operation unit 13 is configured, for example, to include an operation control section 301, an operation section 302, a liquid crystal panel 303, and liquid crystal driver boards 303a and 303b, for example.

The operation control section 301 is configured, for example, by a control board as one embodiment of a hardware module, on which one or a plurality of electric component(s) are mounted. The operation control section 301 includes an operation control circuit 301a, a wireless communication circuit 301b, an image processing circuit 301c, an Interface (I/F) 301d, and a ground output section 301e, for example.

The operation control circuit 301a comprises a CPU, a Read Only Memory (ROM), and a Random Access Memory (RAM), for example. The operation control circuit 301a controls the display of an image on the liquid crystal panel 303 based on an operation signal from the operation section 302 or a control signal from the control section 11 received by the wireless communication circuit 301b. The operation control circuit 301a also controls, based on an operation signal from the operation section 302, the transmission of an operation signal by the wireless communication circuit 301b to the control section 11.

The image processing circuit 301c includes, for example, an image processor (not shown). Upon receiving a control signal from the operation control circuit 301a, the image processing circuit 301c generates an image signal for displaying a predetermined image on the liquid crystal panel 303 and outputs the image signal to the liquid crystal driver boards 303a and 303b.

The I/F 301d functions to receive an operation signal from the operation section 302 to output the operation signal to the operation control circuit 301a.

The ground output section 301e is used to extract current flowing in a ground line configured on the operation unit 13 and is connected to a ground wire 301f. This ground wire 301f is configured, as described later, to be connected to the rotation member main body section 311 and to be grounded via this rotation member main body section 311.

The operation section 302 is composed of a pressure sensitive-type (resistant film-type) touch panel in which transparent electrodes are arranged in a grid-like manner on the display screen of the liquid crystal panel 303. The touch panel detects, by a voltage value, the X and Y coordinates of a force point depressed by a finger or a touch pen, for example, and outputs a signal showing the detected position as an operation signal to the operation control section 301. The operation section 302 includes various operation buttons such as a numerical key group, a “copy” button for instruction of a copy operation, a “stop” button for instruction of stopping an image forming operation such as copying, and a “case binding mode setting” button for instructing the display of an operation screen for performing the setting regarding the case binding mode. The operation section 302 outputs, to the operation control section 301, an operation signal obtained through the button operation. Here, the case binding mode is a mode to align a plurality of papers on which images are already formed, followed by applying adhesive agent to the papers and subsequently covering the papers with a front cover and a back cover, to thereby prepare a book.

The liquid crystal panel 303 as one embodiment of a hardware module is composed, for example, of a Liquid Crystal Display (LCD) and is connected to the liquid crystal driver boards 303a and 303b.

The liquid crystal driver boards 303a and 303b are respectively configured by being provided with a liquid crystal driver (not shown) disposed on a board. Each of the liquid crystal driver boards 303a and 303b drives this liquid crystal driver to cause an image to be displayed on the display screen of the liquid crystal panel 303.

According to the liquid crystal panel 303 and the liquid crystal driver boards 303a and 303b having the configuration as described above, when the liquid crystal driver boards 303a and 303b receive an image signal from the image processing circuit 301c, the liquid crystal drivers are driven to thereby display an image on the display screen of the liquid crystal panel 303.

In this embodiment, a liquid crystal panel is used for image display. However, other image display apparatuses may also be used such as a Cathode Ray Tube (CRT) display, an Electro Luminescence (EL) display, and a plasma display.

In the image forming system 100 of this embodiment, the first paper feeding apparatus 2 and the second paper feeding apparatus 3 are provided as the optional apparatuses (processing apparatuses) at one side of the image forming apparatus main body 1, and the second fixing unit 4, a relay unit 5, the first post-processing optional apparatus 6, and the second post-processing optional apparatus 7 are provided at the other side of the image forming apparatus main body 1, each of which are arranged in a state of being connected to neighboring apparatuses.

The first paper feeding apparatus 2 comprises a housing 2a. The first paper feeding apparatus 2 is structured so that an Auto Document Feeder (ADF) 21 is provided on the upper surface of the housing 2a, and the housing 2a houses therein a scanner 22 and a paper feeding unit 23, for example. In the first paper feeding apparatus 2 having the configuration as described above, the scanner 22 reads the image on a paper automatically fed from the ADF 21 or a paper placed on a platen glass, and obtains image data for the image formation by the image forming apparatus main body 1. Then, the first paper feeding apparatus 2 performs the feeding of a predetermined paper to the image forming apparatus main body 1 by the paper feeding unit 23. This paper feeding unit 23 is an example of an apparatus for performing a predetermined processing on a paper for image formation. With regard to various apparatuses included in the first paper feeding apparatus 2, a configuration may be applied where a control circuit is provided in the first paper feeding apparatus 2 so that the first paper feeding apparatus 2 is controlled by this control circuit, or another configuration may also be applied where a control circuit is not provided in the first paper feeding apparatus 2 and the first paper feeding apparatus 2 is directly controlled by the control section 11 of the image forming apparatus main body 1.

The form of the housing 2a and the grounded structure are the same as those of the image forming apparatus main body 1 and thus will not be described here.

The second paper feeding apparatus 3 comprises a housing 3a. The housing 3a houses therein a paper feeding unit 31, for example. The second paper feeding apparatus 3 having the configuration as described above performs the feeding of a predetermined paper to the image forming apparatus main body 1 by the paper feeding unit 31. This paper feeding unit 31 is an example of an apparatus for performing a predetermined processing on a paper for image formation. With regard to various apparatuses included in the second paper feeding apparatus 3, a configuration may be applied where a control circuit is provided in the second paper feeding apparatus 3 so that the second paper feeding apparatus 3 is controlled by this control circuit, or another configuration may also be applied where a control circuit is not provided in the second paper feeding apparatus 3 and the second paper feeding apparatus 3 is directly controlled by the control section 11 of the image forming apparatus main body 1.

The form of the housing 3a and the grounded structure are the same as those of the image forming apparatus main body 1 and thus will not be described here.

The second fixing unit 4 includes a housing 4a. The housing 4a houses therein the second fixing section 41 for example. The second fixing section 41 provides a further fixing processing to a paper on which the image is formed by the image forming apparatus main body 1 and which is fixed by the fixing section. This second fixing section 41 is an example of an apparatus for performing a predetermined processing on a paper for image formation. With regard to various apparatuses included in the second fixing unit 4, a configuration may be applied where a control circuit is provided in the second fixing unit 4 so that the second fixing unit 4 is controlled by this control circuit, or another configuration may also be applied where a control circuit is not provided in the second fixing unit 4 and the second fixing unit 4 is directly controlled by the control section 11 of the image forming apparatus main body 1.

The form of the housing 4a and the grounded structure are the same as those of the image forming apparatus main body 1 and thus will not be described here.

The relay unit 5 includes a housing 5a. The housing 5a houses therein, for example, a stock apparatus 51, and the like, for temporarily housing a plurality of papers on which images by the image forming apparatus main body 1 are formed. This stock apparatus 51 is an example of an apparatus for performing a predetermined processing on a paper for image formation. With regard to various apparatuses included in the relay unit 5, a configuration may be applied where a control circuit is provided in the relay unit 5 so that the relay unit 5 is controlled by this control circuit, or another configuration may also be applied where a control circuit is not provided in the relay unit 5 and the relay unit 5 is directly controlled by the control section 11 of the image forming apparatus main body 1.

The form of the housing 5a and the grounded structure are the same as those of the image forming apparatus main body 1 and thus will not be described here.

The first post-processing optional apparatus 6 comprises a housing 6a. The housing 6a houses therein the first post-processing device 61 for example. The first post-processing device 61 performs a bending processing or a punch processing on a paper on which the image by the image forming apparatus main body 1 is formed. This first post-processing device 61 is an example of an apparatus for performing a predetermined processing on a paper for image formation. With regard to various apparatuses included in the first post-processing optional apparatus 6, a configuration may be applied where a control circuit is provided in the first post-processing optional apparatus 6 so that the first post-processing optional apparatus 6 is controlled by this control circuit, or another configuration may also be applied where a control circuit is not provided in the first post-processing optional apparatus 6 and the first post-processing optional apparatus 6 is directly controlled by the control section 11 of the image forming apparatus main body 1.

The form of the housing 6a and the grounded structure are the same as those of the image forming apparatus main body 1 and thus will not be described here.

The second post-processing optional apparatus 7 comprises a housing 7a. The housing 7a houses therein the second post-processing device 71, for example. The second post-processing device 71 cuts or applies adhesive agent to a plurality of papers on which images by the image forming apparatus main body 1 are formed, for example, to perform bookbinding. This second post-processing device 71 is an example of an apparatus for performing a predetermined processing on a paper for image formation. With regard to various apparatuses included in the second post-processing optional apparatus 7, a configuration may be applied where a control circuit is provided in the second post-processing optional apparatus 7 so that the second post-processing optional apparatus 7 is controlled by this control circuit, or another configuration may also be applied where a control circuit is not provided in the second post-processing optional apparatus 7 and the second post-processing optional apparatus 7 is directly controlled by the control section 11 of the image forming apparatus main body 1.

The form of the housing 7a and the grounded structure are the same as those of the image forming apparatus main body 1 and thus will not be described here.

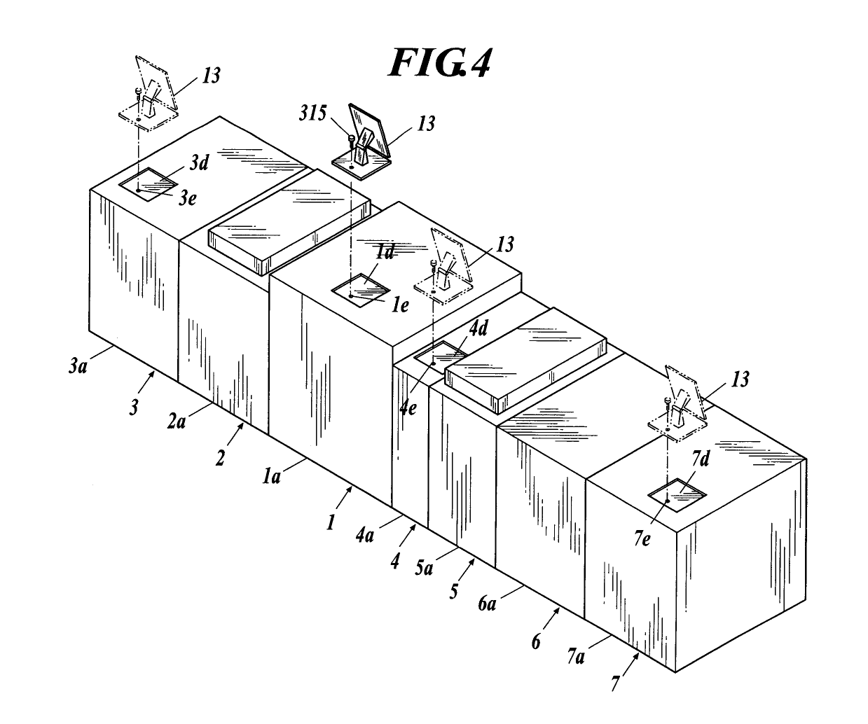

Next, with reference to FIGS. 4 to 6, a configuration example of an attachment/detachment mechanism for allowing the operation unit 13 to be detachably attached to the housings 1a to 7a of the image forming apparatus main body 1 and the optional apparatuses 2 to 7 will be described.

In this embodiment, the operation unit 13 can be detachably provided, as shown in FIG. 4, on concave sections (1d, 3d, 4d, 7d). These concave sections are provided in the respective upper surfaces of housings (1a, 3a, 4a, 7a) of the image forming apparatus main body 1, the second paper feeding apparatus 3, the second fixing unit 4, and the second post-processing optional apparatus 7 and are one embodiment of a placing section.

The first paper feeding apparatus 2, the relay unit 5, and the first post-processing optional apparatus 6 may also be configured so that the operation unit 13 is provided thereon by having, at the upper surfaces of the housings (2a, 5a, 6a), sufficient spaces for placing the operation unit 13. Alternatively, another configuration may also be applied in which the operation unit 13 can be placed on all of the respective upper surfaces of the housings 1a to 7a of the image forming apparatus main body 1 and the optional apparatuses 2 to 7. Another configuration may also be applied in which the operation unit 13 can be placed only on some of the respective upper surfaces of the housings 1a to 7a. Another configuration may also be applied in which the operation unit 13 can be placed on two or more places of the image forming apparatus main body 1 and the optional apparatuses 2 to 7.

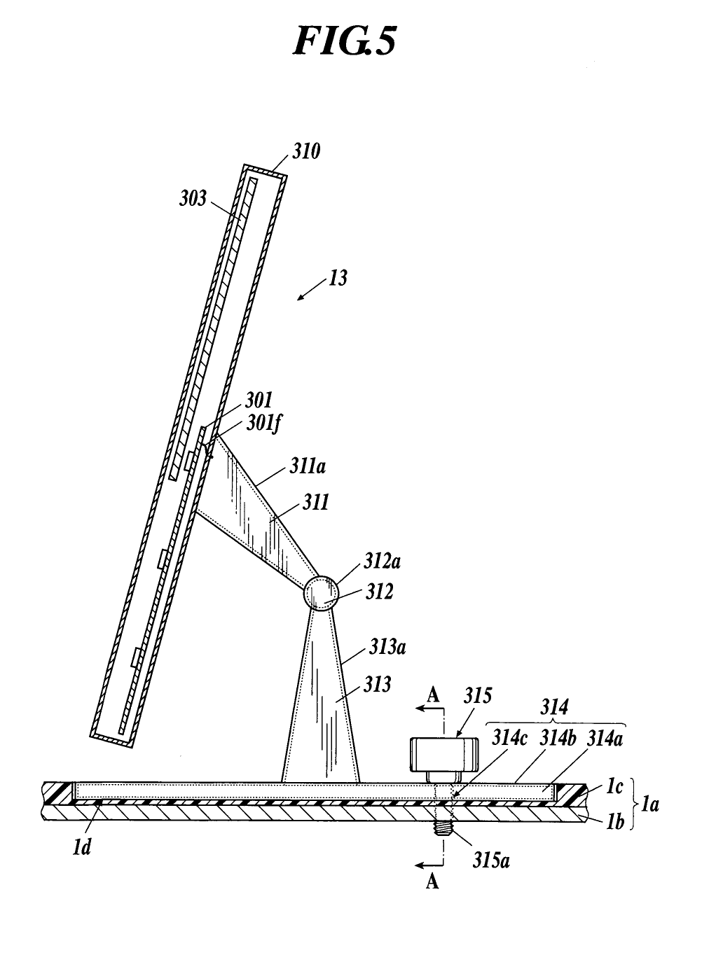

Here, the structure of the operation unit 13 will be described. The operation unit 13 includes, as shown in FIG. 5, an operation section main body 310 housing therein the operation control section 301 and the liquid crystal panel 303, and the like. The operation section main body 310 has, at the back surface thereof, the rotation member main body section 311 that is formed by a conductive metal as one embodiment of conductive material. The rotation member main body section 311 is provided in a projected manner so as to be downwardly inclined with respect to the operation section main body 310. This rotation member main body section 311 is bent, for example, to have a U-like cross section and is configured to have a smaller diameter toward the rear end. This rotation member main body section 311 is connected to the other end of the ground wire 301f whose one end is connected to the ground output section 301e of the operation control section 301. This allows the ground lines of the operation control section 301 and the liquid crystal panel 303, and the like, to be conductive with the rotation member main body section 311. A rotation member cover section 311a is attached to the back surface of the operation section main body 310 so as to cover the outer periphery of the rotation member main body section 311. This rotation member cover section 311a is formed by resin and has thereon a predetermined surface processing for decoration.

The rotation member main body section 311 has an end section that is axially supported by a hinge structure with respect to a rotating axis main body section 312 formed by a conductive metal. The rotation member main body section 311 is configured to be rotatable together with the operation section main body 310 in the up-and-down direction within a range of a predetermined angle. The rotating axis main body section 312 includes a torque limiter to prevent the rotation member main body section 311 from being rotated, unless a torque equal to or higher than a predetermined torque is applied thereto. Another configuration may also be applied where a screw is provided in order to suppress the rotation member main body section 311 from being accidentally rotated. In this configuration, the screw may be tightened to fix the rotation member main body section 311 more securely.

A resin-made rotating axis cover section 312a that covers the rotating axis main body section 312 is provided in the rotating axis main body section 312, at the outer periphery thereof. This rotating axis cover section 312a is attached to a strut cover section 313a, which will be described later. The upper part of rotating axis cover section 312a is partially cut off in order to secure the range of the movement of the rotation member main body section 311.

The lower part of the rotating axis main body section 312 is integrated with a strut main body section 313. The strut main body section 313 is formed by a conductive metal and is bent to have a U-like cross section and is configured to have a diameter that increases from the upper end toward the lower end. The lower end section of the strut main body section 313 is attached to a seating section 314. More specifically, the lower end section of the strut main body section 313 is fixed to a seating main body section 314a formed by the conductive metal, constituting the seating section 314, by a screw, and the like.

The resin-made strut cover section 313a covering the strut main body section 313 is provided in the strut main body section 313, at the outer periphery thereof.

The seating section 314 has a seating main body section 314a whose outer periphery is covered by a resin-made seating covering section 314b. The seating section 314 has, at the rear center part thereof, a penetration hole 314c penetrated by a screw main body section 315a of a screw 315.

The operation unit 13 having the configuration as described above is placed on the housings (1a, 3a, 4a, 7a) of the image forming apparatus main body 1 and the optional apparatuses (3, 4, 7) by allowing the seating section 314 to be mounted on the concave sections (1d, 3d, 4d, 7d) at the upper side of the housings (1a, 3a, 4a, 7a) of the image forming apparatus main body 1 and the optional apparatuses (3, 4, 7). The respective concave sections (1d, 3d, 4d, 7d) have dimensions slightly larger than the external dimensions of the seating section 314 so that the seating section 314 can be positioned within the concave sections (1d, 3d, 4d, 7d). Specifically, the seating section 314 and the concave sections (1d, 3d, 4d, 7d) constitute one embodiment of a positioning mechanism. The respective concave sections (1d, 3d, 4d, 7d) have a depth substantially the same as the thickness of the seating section 314 so that, once the seating section 314 is housed, the upper surface of the housing forms a single plane with the upper surface of the seating section 314. The seating section 314 is fixed to the housings (1a, 3a, 4a, 7a) by using the screw 315 as one embodiment of a tightening member to screw the seating section 314 to the screw receiving sections (1e, 3e, 4e, 7e) of the housing as one embodiment of a receiving hole.

The rotation member main body section 311, the rotating axis main body section 312, the strut main body section 313, and the seating main body section 314a in this embodiment are all composed of a conductive metal, however, may also be composed of other conductive materials including, for example, a resin mixed with a conductive material such as carbon or silver fibers.

Next, an embodiment showing how the placement of the operation unit 13 is made will be described. The operation unit 13 is placed on the image forming apparatus main body 1 and the optional apparatuses (3, 4, 7) in the same manner. Thus, a description is given to an embodiment showing how the operation unit 13 is placed on the image forming apparatus main body 1, and how the operation unit 13 is placed on other optional apparatuses will not described here.

The operation unit 13 is fixed to the housing 1a of the image forming apparatus main body 1 by a predetermined fixing mechanism including the above-described screw 315.

As shown in FIG. 6, the fixing mechanism for the operation unit 13 to the housing 1a is configured by the screw 315 and a screw receiving section 1e provided in the housing 1a, and the like.

The screw 315 is configured to include the screw main body section 315a and a grip section 315d. The screw main body section 315a is configured by integrating a screw section 315b cut in a spiral manner, with a screw head section 315c. The screw head section 315c has, at the upper end section thereof, the grip section 315d to allow the user to rotate the screw 315 easily. The screw main body section 315a is formed by a conductive metal. The grip section 315d is formed by resin.

Next, how to fix the operation unit 13 to the housing 1a by the screw 315 will be described.

The seating section 314 of the operation unit 13 is housed in a concave section 1d. Then, the screw main body section 315a of the screw 315 is inserted to a washer 315e formed by a conductive metal. Then, the screw 315 is inserted to the penetration hole 314c. The penetration hole 314c is formed by allowing the seating main body section 314a to include a hole whose diameter is smaller than that of the hole made in the seating covering section 314b, so that the seating main body section 314a is partially exposed at the upper surface. The washer 315e is formed to have a thin thickness and is shaped to have a doughnut-like shape in which an insertion hole is provided at the center. The insertion hole of the washer 315e has a diameter that is larger than the diameter of the screw section 315b of the screw main body section 315a and that is smaller than the diameter of the screw head section 315c. The screw 315 is rotated to screw the screw section 315b in the screw receiving section 1e. When this screwing operation is continued, the screw head section 315c pushes the seating main body section 314a via the washer 315e. Specifically, the seating main body section 314a is conductive with the housing main body section 1b via the washer 315e and the screw main body section 315a.

As described above, the rotation member main body section 311, the rotating axis main body section 312, the strut main body section 313, and the seating main body section 314a are configured to come in contact with one another. Thus, they are conductive with ground sections such as the operation control section 301 and the liquid crystal panel 303. The seating main body section 314a is conductive with the housing main body section 1b via the screw 315. Specifically, as described above, since the housing main body section 1b is grounded by the ground wire G, current flowing in the ground sections such as the operation control section 301 and the liquid crystal panel 303 is grounded via the ground wire G. As a result, even when the operation of the operation control circuit 301a or the liquid crystal panel 303 causes noise such as Electro-Magnetic Interference (EMI) noise for example, the noise is output from the ground output section 301e and flows in the earth by the ground wire G. Thus, the noise can be effectively suppressed from being emitted outside of the operation unit 13. The electrostatic noise flying from the outside of the operation unit 13 can also be similarly made to flow in the earth, thus providing a superior electrostatic noise resistance. Furthermore, by the screw 315 used to fix the operation unit 13 to the image forming apparatus main body 1 and the optional apparatuses 2 to 7, the operation unit 13 can be provided in a more stable manner. At the same time, the screw 315 provides a secure grounding between the operation unit 13 and an apparatus mounting the operation unit 13 thereon, thus more effectively suppressing noise from being emitted.

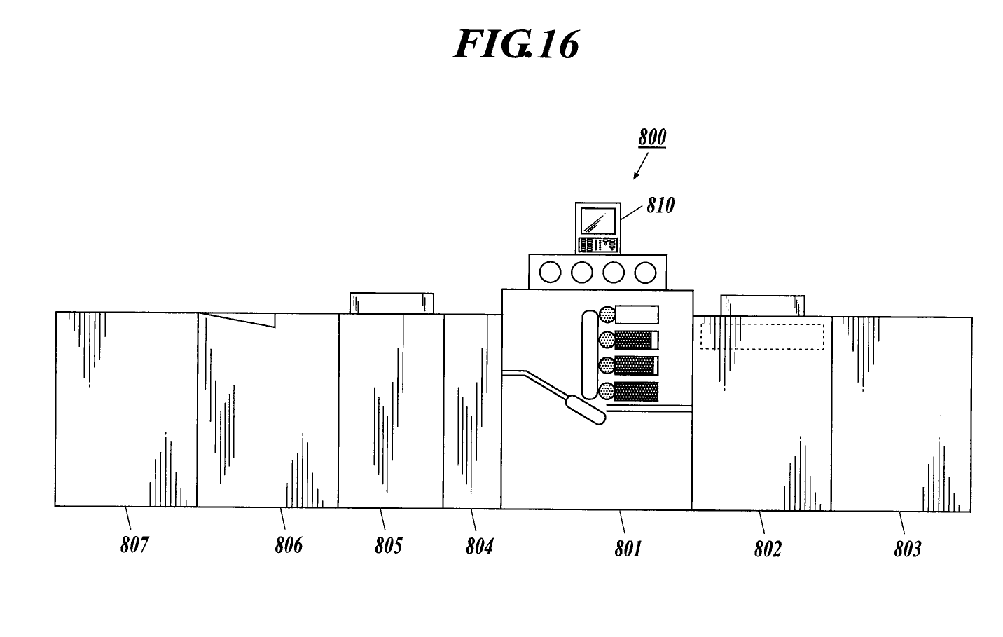

As shown in FIG. 16, in a conventional image forming system 800, an operation unit 810 is provided to be fixed to the uppermost surface of an image forming apparatus main body 801, for example. Thus, when a user operates the operation unit 810 to set a paper type while performing an operation to load papers in the second paper feeding apparatus 802 for example, the user must go back and forth between the operation unit 810 and the second paper feeding apparatus 802, thus causing a deteriorated work efficiency. Furthermore, even when a maintenance guide is displayed on the display screen of the operation unit 810 for example, the displayed contents in the operation unit 810 cannot be visually recognized from a certain position at which the user is working, thus making it difficult for the user to work while confirming a component to be exchanged or the details of the maintenance.

On the other hand, in this embodiment, the operation unit 13 is detachably configured and the operation unit 13 is configured so as to be freely provided at an arbitrary position in the image forming apparatus main body 1 or the optional apparatuses 2 to 7 selected by the user, as described above. Thus, the operation unit 13 can be placed in the vicinity of a position at which the user is working so that the user can easily confirm various settings, a component to be exchanged, or the details of the maintenance, thus providing an improved user convenience and an improved work efficiency.

As described above, according to this embodiment, the main body section 1A includes the housings 1a to 7a for housing an apparatus for performing a processing on a paper such as the image forming section 15, and the main control board 11a for controlling an apparatus such as the image forming section 15. The operation unit 13 is separately provided from the main body section 1A. The operation unit 13 has the operation control section 301 including an electric component or a hardware module such as the liquid crystal panel 303 while being connected to the main control board 11a so that the communication therebetween can be established. The operation unit 13 is detachably provided to the housings 1a to 7a. The operation unit 13 is configured so that the operation unit 13 can be provided at a different position with respect to the housings 1a to 7a. The housings 1a to 7a and the operation unit 13 have conductive materials, respectively. The conductive materials of the housings 1a to 7a (the housing main body sections 1b to 7b) are grounded. The conductive materials of the housing main body sections 1b to 7b and the operation unit 13 are conductive when the operation unit 13 is provided to the housings 1a to 7a. As a result, the operation unit can be placed in the vicinity of a position at which the user is working in such a manner that the user can easily confirm various settings or a component to be exchanged or the details of the maintenance, thus providing an improved user convenience. Furthermore, the grounding issue due to a change of a position at which the operation unit is provided can be solved. Thus, noise in the operation unit can be released efficiently, thus providing an effective measure against noise.

Also according to this embodiment, the housings 1a to 7a have the plurality of concave sections 1d, 3d, 4d, and 7d for mounting the operation unit 13 thereon. The conductive material of the operation unit 13 is conductive with the housing main body sections 1b to 7b when the operation unit 13 is provided to any of the plurality of concave sections 1d, 3d, 4d, and 7d. As a result, the operation unit can be provided at a plurality of positions desired by a designer. Furthermore, the operation unit can be placed more stably.

Also according to this embodiment, the positioning mechanism is provided to position the operation unit 13 to the concave sections 1d, 3d, 4d, and 7d. As a result, the operation unit can be guided to a position desired by the designer. Thus, the operation unit can be attached easily.

Also according to this embodiment, the fixing mechanism is provided to fix the operation unit 13 to the housings 1a to 7a at a position to which the operation unit 13 is attached. Thus, the operation unit can be placed more stably.

Also according to this embodiment, the fixing mechanism is configured to have the screw 315 and the screw receiving sections 1e, 3e, 4e, and 7e configured to include a conductive material. The fixing mechanism is also configured so that the screw receiving sections 1e, 3e, 4e, and 7e are provided in the housings 1a to 7a and the screw 315 is allowed to penetrate a part of the operation unit 13 to thereby tighten the screw 315 to the screw receiving sections 1e, 3e, 4e, and 7e, thus fixing the operation unit 13 to the housings 1a to 7a. When the operation unit 13 is provided on the housings 1a to 7a and is tightened by the screw 315 together with the housings 1a to 7a, the conductive material of the operation unit 13 is conductive, via the screw 315, with the housing main body sections 1b to 7b. As a result, the operation unit can be fixed easily.

Also according to this embodiment, the ground section of a hardware module such as the operation control section 301 and the liquid crystal panel 303 is allowed to be conductive with the conductive material of the operation unit 13. Thus, noise in the operation unit can be released in a more efficient manner.

Also according to this embodiment, the housings 2a to 7a house therein an apparatus for performing a processing on a paper for image formation. The housings 2a to 7a include grounded housing main body sections 2b to 7b. The operation unit 13 includes the hardware module such as the operation control section 301 on which electric component is mounted and the liquid crystal panel 303, while being connected to the image forming apparatus main body 1 so that the communication therebetween can be established. Further, when the operation unit 13, having a conductive material that can be provided at a different position to the housings 2a to 7a and are detachable to the housings 2a to 7a, is placed on the housings 2a to 7a, the housing main body sections 2b to 7b are conductive with the conductive material of the operation unit 13. As a result, the operation unit can be placed in the vicinity of a position at which a user is working in such a manner that the user can easily confirm various settings or a component to be exchanged or the details of the maintenance, thus providing an improved user convenience. Furthermore, the grounding issue due to a change of a position at which the operation unit is provided can be solved. Thus, noise in the operation unit can be released efficiently, thus providing an effective measure against noise.

The description in this embodiment illustrates an example of an image forming apparatus and an optional apparatus according to the present invention. The invention is not limited to this. Thus, an appropriate change can be made in the detailed configurations and the detailed operations of the respective functional sections constituting the image forming apparatus and the optional apparatus.

Furthermore, a screw made by a conductive metal is used as a fixing mechanism in this embodiment. However, the fixing mechanism may also be formed by other materials including, for example, a fixing pin formed by conductive resin. In this case, when this fixing pin is inserted to a penetration hole penetrating a seating section and a housing and a tip end of the fixing pin penetrates the penetration hole, then the tip end of the fixing pin is elastically deformed and is locked to the inner periphery surface of the housing to thereby fix the operation unit to the housing. When this configuration is provided so that the fixing pin can be pulled out by being pulled at a predetermined force, the operation unit can be attached or detached more easily.

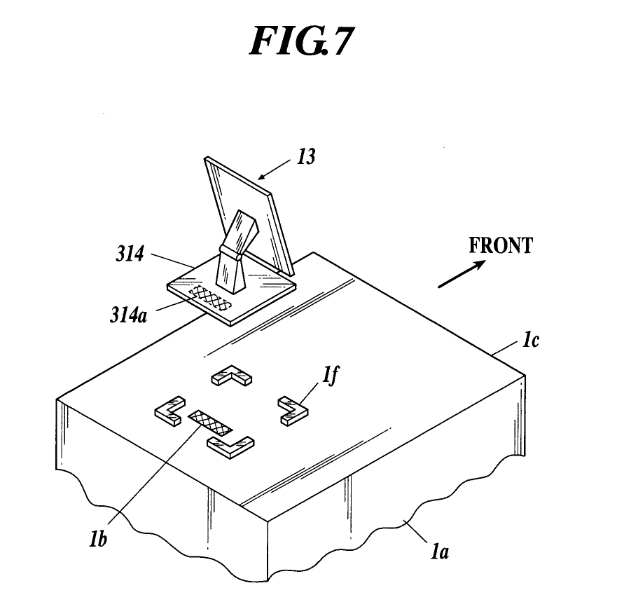

Also in this embodiment, the operation unit 13 is positioned by a concave section provided in a housing. However, other configurations may also be applied to position the operation unit 13. For example, as shown in FIG. 7, a configuration may be applied where the upper surface of the housing 1a includes a plurality of L-shaped ribs if that are provided in accordance with the outer periphery of the seating section 314 to thereby constitute a positioning mechanism for positioning the operation unit 13. In this example, a part of the housing main body section 1b is upwardly exposed at the upper surface so as to correspond to a downwardly-exposed part of the seating main body section 314a of the operation unit 13. When the operation unit 13 is placed on the housing 1a, the housing main body section 1b comes in contact with the seating main body section 314a to achieve the conduction therebetween. The conduction between the housing main body section 1b and the seating main body section 314a can also be realized by other methods.

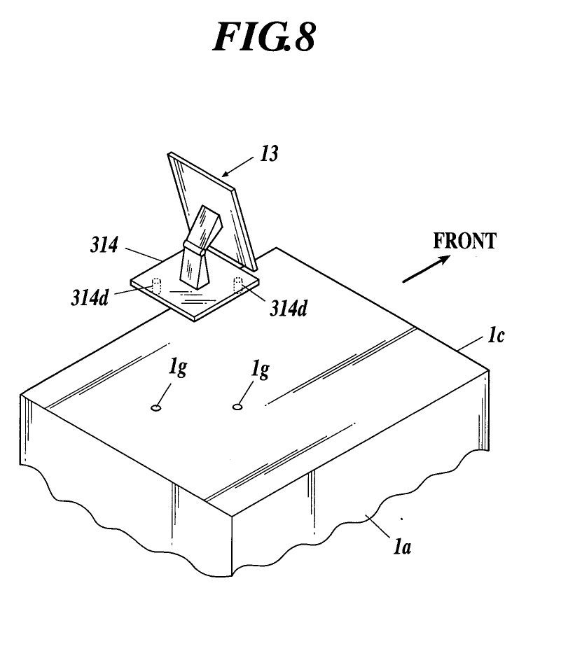

As shown in FIG. 8, another positioning mechanism may also be configured in which a plurality of positioning bosses 314d are downwardly provided in a projecting manner at predetermined positions at the lower surface of the seating section 314 of the operation unit 13, and boss receiving holes 1g are provided at the upper surface of the housing 1a so as to correspond to the positions at which the positioning bosses 314d are provided. In this configuration, the positioning bosses 314d can be engaged with the boss receiving holes 1g to thereby position the operation unit 13. In this example, the positioning bosses 314d formed of a conductive material is conductive with the seating main body section 314a and the housing main body section 1b is exposed in the boss receiving holes 1g. When the operation unit 13 is provided, the positioning bosses 314d come in contact with the housing main body section 1d to establish the conduction therebetween. The conduction between the housing main body section 1b and the seating main body section 314a can also be realized by other methods.

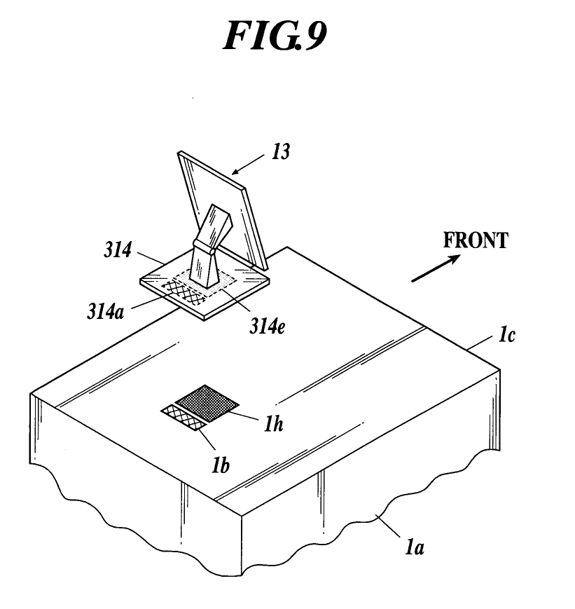

In this embodiment, the screw 315 was used to fix the operation unit 13 to the housing 1a. Other configurations may also be applied to fix the operation unit 13. For example, as shown in FIG. 9, magnet 314e is provided at predetermined position in the lower surface of the seating section 314 of the operation unit 13 so that the magnet 314e correspond to a magnet 1h provided at the upper surface of the housing 1a to thereby configure a fixing mechanism. In this configuration, the magnet 314e and the magnet 1h are magnetically attracted to each other to thereby fix the operation unit 13. In this example, the same configuration as that in the example shown in FIG. 7 is applied to cause the housing main body section 1b to be conductive with the seating main body section 314a. However, the conduction therebetween can also be achieved by other methods.

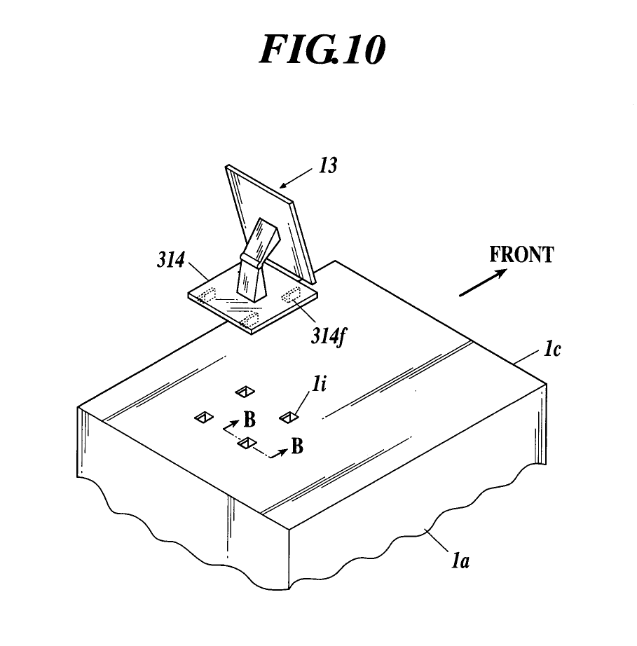

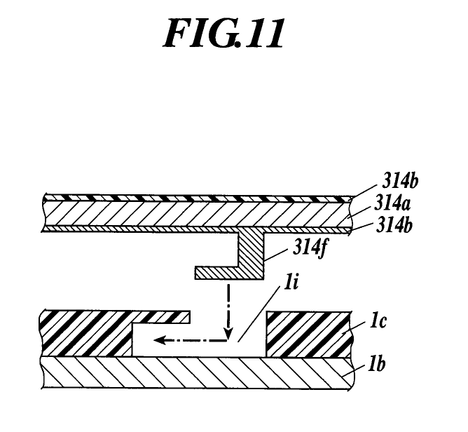

Another configuration as shown in FIG. 10 may also be applied where a plurality of L-shaped engagement pieces 314f are downwardly provided in a projected manner at predetermined positions in the lower surface of the seating section 314 of the operation unit 13 so as to correspond to L-shaped engagement grooves 1i provided at the upper surface of the housing 1a to thereby configure a positioning mechanism and a fixing mechanism. In this configuration, as shown in FIG. 11, the engagement pieces 314f are inserted to the opening parts of the engagement grooves 1i. Then, the operation unit 13 can be slid to a position at which the engagement pieces 314f and the engagement grooves 1i are engaged to each other to thereby position and fix the operation unit 13. In this example, the engagement pieces 314f formed by a conductive material are caused to be conductive with the seating main body section 314a and the housing main body section 1b is exposed in the engagement grooves 1i. When the operation unit 13 is provided, the engagement pieces 314f come in contact with the housing main body section 1d to achieve the conduction therebetween. The conduction between the housing main body section 1b and the seating main body section 314a can also be realized by other methods.

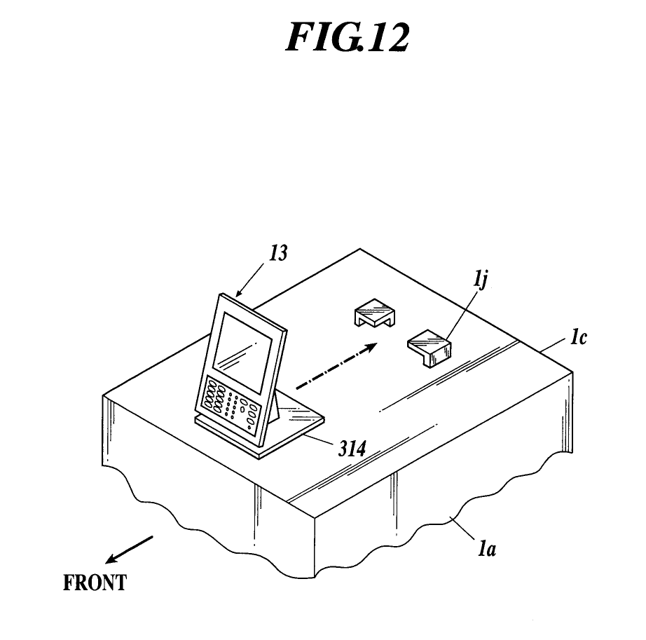

Another configuration as shown in FIG. 12 may also be applied where a plurality of rectangular lock pieces 1j are provided at the upper surface of the housing 1a that are opened to the front side and the center. These lock pieces 1j are provided in a projected manner with a predetermined interval therebetween so that the lock pieces 1j house therein the corners of the seating section 314 of the operation unit 13 to thereby configure a positioning mechanism and a fixing mechanism. In this configuration, the operation unit 13 can be slid from the front side to engage the corners of the seating section 314 to the plurality of engagement pieces 1j to thereby position and fix the operation unit 13. The conduction between the housing main body section 1b and the seating main body section 314a can be established by any configuration appropriately using any of the above-described methods.

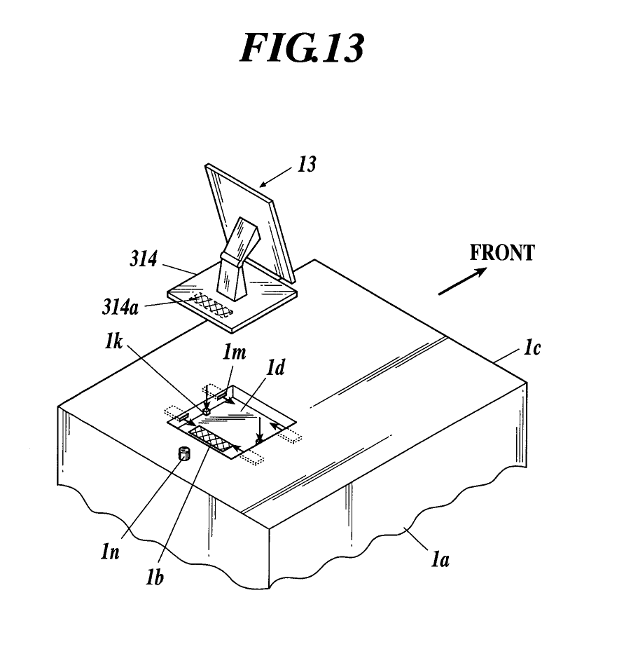

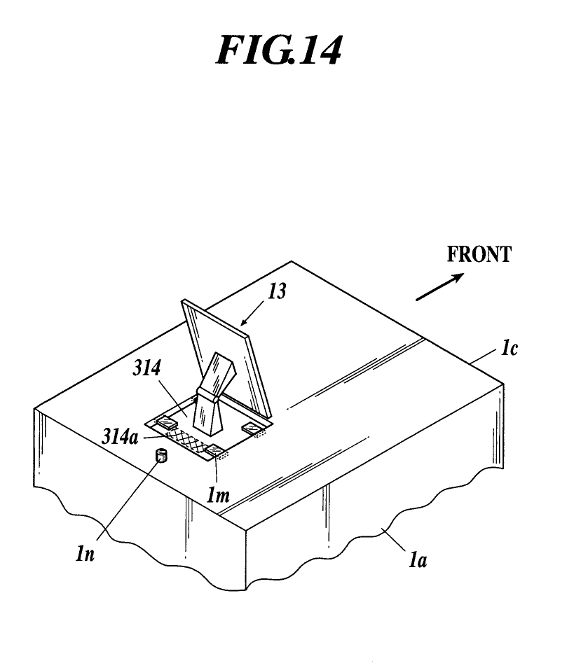

Another configuration as described below can also be applied to position and fix the operation unit 13. Specifically, as shown in FIG. 13, a plurality of operation pieces 1k are provided at predetermined positions at both ends of the bottom surface of the concave section 1d of the housing 1a. These operation pieces 1k are dislocated when being depressed from the upper side downwardly. A plurality of retaining pieces 1m are also provided at predetermined positions at side surfaces of the concave section 1d so as to correspond to the positions of the operation pieces 1k. These retaining pieces 1m are moved back and forth in the concave section 1d depending on the positions of operation pieces 1k and are provided as one embodiment of a fixing mechanism. When the seating section 314 of the operation unit 13 is housed in the concave section 1d, the bottom surface of the seating section 314 downwardly depresses the operation pieces 1k as shown in FIG. 14. Then, by a known link mechanism, the movement of the operation piece 1k causes the retaining pieces 1m to enter the concave section 1d, thereby suppressing the seating section 314 from being upwardly detached. Specifically, the operation unit 13 is positioned by the concave section 1d and is fixed to the housing 1a by the retaining pieces 1m. When a user depresses a cancellation button 1n provided at the rear side of the concave section 1d, the depression of the cancellation button 1n can cause, by a known link mechanism, the retaining pieces 1m to be retracted from the concave section 1d, thereby achieving the detachment of the operation unit 13. In this example, the same configuration as that shown in FIG. 7 is applied to provide the conduction between the housing main body section 1b and the seating main body section 314a. However, the conduction therebetween can also be achieved by other methods.

As described above, an example has been described where the configurations shown in FIG. 7 to FIG. 14 are applied to the image forming apparatus main body 1. However, these configurations can also be applied to the optional apparatuses 2 to 7.

In this embodiment, the operation unit 13 is configured so that the operation unit 13 can have a wireless communication with the control section 11 of the image forming apparatus main body 1. However, another configuration may also be applied where the operation unit 13 is connected to the image forming apparatus main body 1 by a wiring to provide a wired communication therebetween. In this case, the wiring preferably has a length set so that the operation unit 13 can be provided to any of the optional apparatuses 2 to 7. In the case of the configuration where the operation unit 13 is connected to the image forming apparatus main body 1 by a wired communication, noise generated in the operation unit 13 can be easily emitted to the outside via the wiring used as an antenna. The noise can be reduced by an application of the present invention.

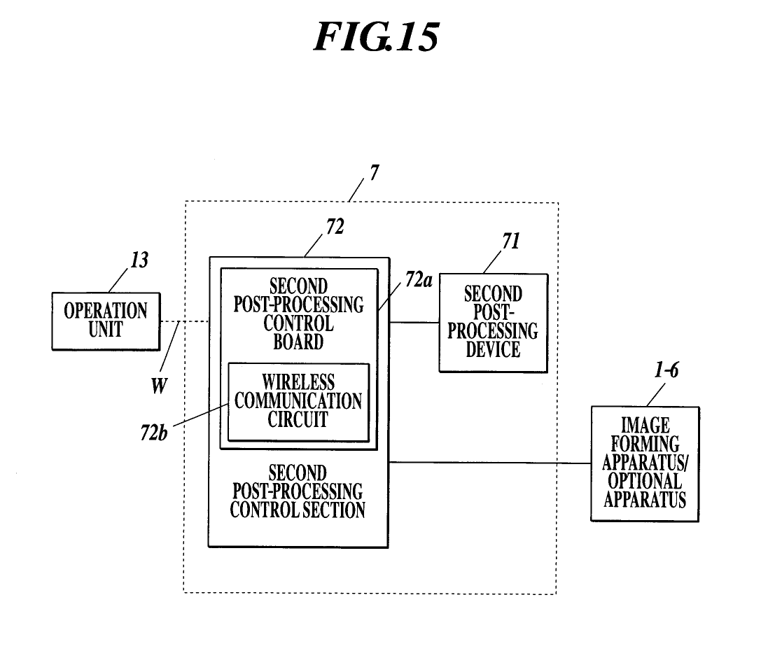

The operation unit 13 may also be configured so as to be able to have communication not only to the image forming apparatus main body 1 but also to the optional apparatuses 2 to 7. For example, in the example shown in FIG. 15, the housing 7a of the second post-processing optional apparatus 7 houses therein the second post-processing device 71 and the second post-processing control section 72 for controlling the second post-processing device 71. The second post-processing control section 72 includes the second post-processing control board 72a having a wireless communication circuit 72b for the communication with the operation unit 13 via the wireless W. In this case, when the operation unit 13 is placed on the second post-processing optional apparatus 7 for example, the communication target for the operation unit 13 can be switched from the control section 11 of the image forming apparatus main body 1 to the second post-processing control section 72, by automatically detecting the placement of the operation unit 13 by the control section 11 of the image forming apparatus main body 1 or the second post-processing control section 72 of the second post-processing optional apparatus 7, or by the operation of the operation unit 13, for example. This configuration can be applied for the maintenance of the second post-processing optional apparatus 7, for example. This configuration can also be applied for other optional apparatus 2 to 6.

In this embodiment, an operation unit is used as a peripheral apparatus. However, the present invention can also be applied to other electric apparatuses that are detachably configured, that can have wired or wireless communication with the control section of the image forming apparatus main body, and that have a hardware module including, for example, a display unit only having a display function or a Universal Serial Bus (USB) port.

In this embodiment, another configuration may also be applied where no placing section is provided and an operation panel can be provided at any position by securing the conduction between the operation unit 13 and the image forming apparatus main body 1 and the optional apparatuses 2 to 7.

In this embodiment, another configuration may also be applied where either of the positioning mechanism or the fixing mechanism, or even both thereof may not provided.

In this embodiment, a configuration is applied in which the ground output section 301e of the operation control section 301 is connected to the rotation member main body section 311 via the ground wire 301f. However, another configuration may also be applied in which the back surface side of the operation control section 301 or the liquid crystal panel 303 has a metal shield plate for receiving emitted noise so that the conduction can be achieved between this shield plate and the rotation member main body section 311, for example.

In this embodiment, the screw 315 is used to provide the conduction between the conductive material of the operation unit 13 and the conductive materials of the housings 1a to 7a. However, this conduction can also be achieved by a ground wire or a member using other conductive materials.

According to one aspect of the preferred embodiments of the present invention, there is provided an image forming apparatus to form an image on a paper, comprising:

a main body section including a housing to house an apparatus to perform processing for the paper, and a control circuit to control the apparatus housed in the housing; and

a peripheral apparatus which is provided separately from the main body section, which includes a hardware module having an electric component, and is connected to the control circuit so that communication between the peripheral apparatus and the control circuit is performed, and which is detachably provided to the housing, wherein

a position at which the peripheral apparatus is provided to the housing can be changed, wherein

the housing and the peripheral apparatus respectively include a conductive material, and the conductive material of the housing is grounded, and wherein

when the peripheral apparatus is provided to the housing, the conductive material of the housing is conductive with the conductive material of the peripheral apparatus.

Preferably, the housing comprises a plurality of placing sections to place the peripheral apparatus, and wherein

when the peripheral apparatus is provided to any one of the plurality of placing sections, the conductive material of the peripheral apparatus is conductive with the conductive material of the housing.

Preferably, the image forming apparatus further comprises a positioning mechanism to position the peripheral apparatus to any one of the placing sections.

Preferably, the image forming apparatus further comprises a fixing mechanism to fix the peripheral apparatus to the housing at the position at which the peripheral apparatus is provided.

Preferably, the fixing mechanism comprises a tightening member which includes a conductive material; and a receiving hole, the receiving hole being provided in the housing, and the tightening member penetrating a part of the peripheral apparatus and being tightened to the receiving hole, so as to fix the peripheral apparatus to the housing, and wherein

when the peripheral apparatus is provided on the housing and is tightened by the tightening member together with the housing, the conductive material of the peripheral apparatus is conductive with the conductive material of the housing, via the tightening member.

Preferably, a ground section of the hardware module is conductive with the conductive material of the peripheral apparatus.

According to another aspect of the preferred embodiments of the present invention, there is provided a processing apparatus being connected to an image forming apparatus which forms an image on a paper, to perform predetermined processing for the paper subjected to an image formation by the image forming apparatus, comprising:

a housing to house an apparatus which performs processing for the paper, the housing including a grounded conductive material, wherein

when a peripheral apparatus comprising a conductive material is provided to the housing, the grounded conductive material of the housing is conductive with the conductive material of the peripheral apparatus, the peripheral apparatus further comprising a hardware module including an electric component, and being connected to the image forming apparatus so that communication between the peripheral apparatus and the image forming apparatus is performed, the peripheral apparatus being detachably provided to the housing, and wherein a position at which the peripheral apparatus is provided to the housing can be changed.

Preferably, the processing apparatus further comprises a positioning mechanism to position the peripheral apparatus to any one of the placing sections.

Preferably, the processing apparatus further comprises a fixing mechanism to fix the peripheral apparatus to the housing at the position at which the peripheral apparatus is provided.

According to the preferred embodiments of the present invention, user convenience can be improved, and an effective measure against noise can be provided.

What is claimed is:

1. An image forming apparatus to form an image on a paper, comprising:
a main body section including a housing to house an apparatus to perform processing for the paper, and a control circuit to control the apparatus housed in the housing; and
a peripheral apparatus which is provided separately from the main body section, which includes a hardware module having an electric component, and is connected to the control circuit so that communication between the peripheral apparatus and the control circuit is performed, and which is detachably provided to the housing, wherein
a position at which the peripheral apparatus is provided to the housing can be changed, wherein
the housing and the peripheral apparatus respectively include a conductive material, and the conductive material of the housing is grounded, and wherein
when the peripheral apparatus is provided to the housing, the conductive material of the housing is conductive with the conductive material of the peripheral apparatus.

2. The image forming apparatus according to claim 1, wherein the housing comprises a plurality of placing sections to place the peripheral apparatus, and wherein
when the peripheral apparatus is provided to any one of the plurality of placing sections, the conductive material of the peripheral apparatus is conductive with the conductive material of the housing.

3. The image forming apparatus according to claim 2, wherein the image forming apparatus further comprises a positioning mechanism to position the peripheral apparatus to any one of the placing sections.

4. The image forming apparatus according to claim 1, wherein the image forming apparatus further comprises a fixing mechanism to fix the peripheral apparatus to the housing at the position at which the peripheral apparatus is provided.

5. The image forming apparatus according to claim 4, wherein the fixing mechanism comprises a tightening member which includes a conductive material; and a receiving hole, the receiving hole being provided in the housing, and the tightening member penetrating a part of the peripheral apparatus and being tightened to the receiving hole, so as to fix the peripheral apparatus to the housing, and wherein
when the peripheral apparatus is provided on the housing and is tightened by the tightening member together with the housing, the conductive material of the peripheral apparatus is conductive with the conductive material of the housing, via the tightening member.

6. The image forming apparatus according to claim 1, wherein a ground section of the hardware module is conductive with the conductive material of the peripheral apparatus.

7. A processing apparatus being connected to an image forming apparatus which forms an image on a paper, to perform predetermined processing for the paper subjected to an image formation by the image forming apparatus, comprising:
a housing to house an apparatus which performs processing for the paper, the housing including a grounded conductive material, wherein
when a peripheral apparatus comprising a conductive material is provided to the housing, the grounded conductive material of the housing is conductive with the conductive material of the peripheral apparatus, the peripheral apparatus further comprising a hardware module including an electric component, and being connected to the image forming apparatus so that communication between the peripheral apparatus and the image forming apparatus is performed, the peripheral apparatus being detachably provided to the housing, and wherein a position at which the peripheral apparatus is provided to the housing can be changed.

8. The processing apparatus according to claim 7, wherein the housing comprises a plurality of placing sections to place the peripheral apparatus, and wherein
when the peripheral apparatus is provided to any one of the plurality of placing sections, the conductive material of the peripheral apparatus is conductive with the conductive material of the housing.

9. The processing apparatus according to claim 8, wherein the processing apparatus further comprises a positioning mechanism to position the peripheral apparatus to any one of the placing sections.

10. The processing apparatus according to claim 7, wherein the processing apparatus further comprises a fixing mechanism to fix the peripheral apparatus to the housing at the position at which the peripheral apparatus is provided.

11. The processing apparatus according to claim 10, wherein the fixing mechanism comprises a tightening member which includes a conductive material; and a receiving hole, the receiving hole being provided in the housing, and the tightening member penetrating a part of the peripheral apparatus and being tightened to the receiving hole, so as to fix the peripheral apparatus to the housing, and wherein
when the peripheral apparatus is provided on the housing and is tightened by the tightening member together with the housing, the conductive material of the peripheral apparatus is conductive with the conductive material of the housing, via the tightening member.
